(19) United States
(12) Patent Application Publication
(10) Pub. No.: US 2024/0284245 A1
(43) Pub. Date: Aug. 22, 2024

(54) QUALITY OF SERVICE CONTROL METHOD, CORE NETWORK ELEMENT, ACCESS NETWORK DEVICE AND TERMINAL DEVICE

(71) Applicant: GUANGDONG OPPO MOBILE TELECOMMUNICATIONS CORP., LTD., Dongguan (CN)

(72) Inventor: Yali GUO, Dongguan (CN)

(73) Assignee: GUANGDONG OPPO MOBILE TELECOMMUNICATIONS CORP., LTD., Dongguan (CN)

(21) Appl. No.: 18/649,518

(22) Filed: Apr. 29, 2024

Related U.S. Application Data
(63) Continuation of application No. PCT/CN2021/134671, filed on Nov. 30, 2021.

(51) Int. Cl. H04W 28/02

(52) U.S. Cl. CPC H04W 28/0268; H04W 28/0236

(57) ABSTRACT

A method for controlling Quality of Service (QOS) is provided, which includes that: a first core network element determines a QoS flow corresponding to a Service Date Flow (SDF) based on first media unit control information of the SDF, and sends an identifier of the Qos flow and second media unit control information. A first core network element and a third core network element are further provided.

### CROSS-REFERENCE TO RELATED APPLICATION

This is a continuation of International Patent Application No. PCT/CN2021/134671, filed on Nov. 30, 2021, the disclosure of which is hereby incorporated by reference in its entirety.

### BACKGROUND

In a 5th-Generation (5G) system, application layer data interacted between a terminal device and an application server or between the terminal device and a peer terminal device are usually data that has been encoded and compressed in a specific way. During the encoding process, a sender may divide media data into multiple media units, and each media unit is encoded independently. After receiving the data, a receiver decodes each media unit separately, and then combines them to obtain the entire media data.

### SUMMARY

The disclosure relates to the field of communications, and more particularly to a method for controlling Quality of Service (QOS), and core network elements.

An embodiment of the disclosure provides a method for controlling QoS, which includes the following operations.

A first core network element determines a QoS flow corresponding to a Service Date Flow (SDF) based on first media unit control information of the SDF, and sends an identifier of the QoS flow (QOS Flow Identifier, QFI) and second media unit control information.

An embodiment of the disclosure further provides a first core network element, which includes a processor, a memory for storing a computer program, and a transceiver.

The processor is configured to call the computer program stored in the memory and run the computer program to: determine a QoS flow corresponding to an SDF based on first media unit control information of the SDF; and control the transceiver to send a QFI and second media unit control information.

An embodiment of the disclosure further provides a third core network element, which includes a processor, a memory for storing a computer program, and a transceiver.

The processor is configured to call the computer program stored in the memory and run the computer program to: control the transceiver send first media unit control information of an SDF to a first core network element. The first media unit control information is used for determining a QoS flow corresponding to the SDF.

### BRIEF DESCRIPTION OF THE DRAWINGS

FIG. 1 is a schematic diagram of architecture of a communication system according to an embodiment of the disclosure.

FIG. 2 is a schematic diagram of architecture of a 5G system according to an embodiment of the disclosure.

FIG. 3 is a schematic diagram illustrating a QoS model of a 5G network according to an embodiment of the disclosure.

FIG. 4 is a schematic flowchart illustrating a method for controlling Qos according to an embodiment of the disclosure.

FIG. 5 is a schematic flowchart illustrating a method for controlling QoS according to another embodiment of the disclosure.

FIG. 6 is a schematic flowchart illustrating a method for controlling QoS according to another embodiment of the disclosure.

FIG. 7 is a schematic flowchart illustrating a method for controlling QoS according to another embodiment of the disclosure.

FIG. 8 is a schematic flowchart illustrating a method for controlling QoS according to another embodiment of the disclosure.

FIG. 9 is a schematic flowchart illustrating a method for controlling QoS according to another embodiment of the disclosure.

FIG. 10 is a schematic diagram illustrating an interaction between various devices in an application example of the disclosure.

FIG. 11 is a schematic block diagram of a first core network element according to an embodiment of the disclosure.

FIG. 12 is a schematic block diagram of a second core network element according to an embodiment of the disclosure.

FIG. 13 is a schematic block diagram of a second core network element according to another embodiment of the disclosure.

FIG. 14 is a schematic block diagram of an access network device according to an embodiment of the disclosure.

FIG. 15 is a schematic block diagram of an access network device according to another embodiment of the disclosure.

FIG. 16 is a schematic block diagram of a terminal device according to an embodiment of the disclosure.

FIG. 17 is a schematic block diagram of a third core network element according to an embodiment of the disclosure.

FIG. 18 is a schematic block diagram of a third core network element according to another embodiment of the disclosure.

FIG. 19 is a schematic block diagram of an application network element according to an embodiment of the disclosure.

FIG. 20 is a schematic block diagram of a communication device according to an embodiment of the disclosure.

FIG. 21 is a schematic block diagram of a chip according to an embodiment of the disclosure.

### DETAILED DESCRIPTION

The technical solutions in the embodiments of the disclosure will be described below in combination with the drawings in the embodiments of the disclosure.

The technical solutions in the embodiments of the disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolved NR system, an LTE-based access to unlicensed spectrum (LTE-U) system, an NR-based access to unlicensed spectrum (NR-U) system, a Non-Terrestrial Network (NTN) system, a Universal Mobile Telecommunication System (UMTS), a Wireless Local Area Network (WLAN), a Wireless Fidelity (WiFi), a 5G system or other communication systems.

In general, a traditional communication system supports a limited number of connections and is easy to be implemented. However, with the development of communication technologies, a mobile communication system will not only support the traditional communication, but also support, for example, a Device to Device (D2D) communication, a Machine to Machine (M2M) communication, a Machine Type Communication (MTC), a Vehicle to Vehicle (V2V) communication, or a Vehicle to everything (V2X) communication, etc. The embodiments of the disclosure may also be applied to these communication systems.

Optionally, the communication system in the embodiments of the disclosure may be applied to a Carrier Aggregation (CA) scenario, a Dual Connectivity (DC) scenario, and a Standalone (SA) network deployment scenario.

The embodiments of the disclosure describe various implementations in combination with a network device and a terminal device. The terminal device may be referred to as User Equipment (UE), an access terminal, a user unit, a user station, a mobile station, a mobile platform, a remote station, a remote terminal, a mobile device, a user terminal, a terminal, a wireless communication device, a user agent, a user device or the like.

The terminal device may be a station (ST) in WLAN, a cellular telephone, a cordless phone, a Session Initiation Protocol (SIP) phone, a Wireless Local Loop (WLL) station, a Personal Digital Processing (PDA) device, a handheld device with a wireless communication function, a computing device or other processing device connected to a wireless modem, a vehicle-mounted device, a wearable device, a terminal device in a next generation communication system such as an NR network, a terminal device in a future evolved Public Land Mobile Network (PLMN) or the like.

In the embodiments of the disclosure, the terminal device may be deployed on land including indoor or outdoor, hand-held, wearable or vehicle-mounted, may also be deployed on a water surface (such as ships), and may further be deployed in the air (such as airplanes, balloons, satellites and the like).

In the embodiments of the disclosure, the terminal device may be a Mobile Phone, a Pad, a computer with a wireless transceiver function, a Virtual Reality (VR) terminal device, an Augmented Reality (AR) terminal device, a wireless terminal device in an industrial control, a wireless terminal device in a self-driving, a wireless terminal device in a remote medical, a wireless terminal device in a smart grid, a wireless terminal device in a transportation safety, a wireless terminal device in a smart city, a wireless terminal device in a smart home, or the like.

In the embodiments of the disclosure, as an example rather than a limitation, the terminal device may further be a wearable device. The wearable device, known as a wearable smart device, is a collective term of wearable devices which are developed by using wearable technology to intelligently design daily wearable items, such as glasses, gloves, watches, clothing and shoes. The wearable device is a portable device that is worn directly on the body or integrated into the clothes or accessories of a user. The wearable device is not only a hardware device, but also can realize a powerful function through software support, data interaction and cloud interaction. Broadly speaking, the wearable smart devices include, for example, smart watches or smart glasses, which have full functions, large size, and may realize complete or partial functions without relying on smart phones, and various smart bracelets and smart jewelry for physical sign monitoring, which only focus on a certain type of an application function and need to be used in conjunction with other devices such as smart phones.

In the embodiments of the disclosure, the network device may include a device for communicating with a mobile device, for example, an access network device. The network device may be an Access Point (AP) in WLAN, a Base Transceiver Station (BTS) in GSM or CDMA, a NodeB (NB) in WCDMA, an Evolved Node B (eNB or eNodeB) in LTE, a relay station or an access point, or a vehicle-mounted device, a wearable device, an access network device (gNB) in an NR network, an access network device in a future evolved PLMN or the like.

The network device may further be a core network device, for example, an Access and Mobility Management Function (AMF), a Session Management Function (SMF) and other network entities. The embodiments of the disclosure are not limited thereto.

In the embodiments of the disclosure, as an example rather than a limitation, the network device may have mobility characteristics. For example, the network device may be a mobile device. Optionally, the network device may be a satellite or a balloon station. For example, the satellite may be a low-Earth orbit (LEO) satellite, a medium-Earth orbit (MEO) satellite, a geostationary Earth orbit (GEO) satellite, a high elliptical orbit (HEO) satellite and the like. Optionally, the network device may further be a base station arranged on land, water and the like.

In the embodiments of the disclosure, the access network device may provide a service for a cell, and the terminal device communicates with the network device through transmission resources (for example, frequency domain resources, or spectrum resources) used by the cell. The cell may be a cell corresponding to the access network device (for example, the base station), and the cell may belong to a macro base station or belong to a base station corresponding to a small cell. The small cell may include: a Metro cell, a Micro cell, a Pico cell, a Femto cell and the like. These small cells have the characteristics of small coverage and low transmission power, and are suitable for providing a high-speed data transmission service.

FIG. 1 schematically illustrates a wireless access system 1000 including one access network device 1100 and two terminal devices 1200. Optionally, the wireless communication system 1000 may include multiple access network devices 1100, and other numbers of terminal devices may be included within the coverage range of each network device 1100. Optionally, the system 1000 may further include the core network device, for example, the AMF, a User Plane Function (UPF) and other network entities.

It should be understood that a device with a communication function in a network/system in the embodiments of the disclosure may be referred to as a communication device. For example, in the communication system illustrated in FIG. 1, the communication device may include the network device and the terminal device with the communication function, which may be specific devices in the embodiments of the disclosure.

It should be understood that the terms “system” and “network” used herein are often used interchangeably. The term “and/or” is used herein to describe an association relationship between associated objects and represents that three relationships may exist between the associated objects. For example, A and/or B may represent three conditions: independent existence of A, existence of both A and B and independent existence of B. In addition, the character “/” used herein usually represents that the associated objects before and after the character “/” form an “or” relationship.

It should be understood that the “indication” mentioned in the embodiments of the disclosure may be a direct indication, an indirect indication, or a representation of an association relationship. For example, A indicates B, which may represent that A directly indicates B, for example, B may be obtained through A; A indicates B, which may also represent that A indirectly indicates B, for example, A indicates C, and B may be obtained through C; A indicates B, which may further represent that there is an association between A and B.

In the description of the embodiments of the disclosure, the term “corresponding to” may represent a direct correspondence or an indirect correspondence between two items, may also represent an association relationship between the two items, and may further be a relationship such as indication and being indicated, configuration and being configured or the like.

In order to facilitate understanding of the technical solutions in the embodiments of the disclosure, the related art about the embodiments of the disclosure is described below, and the related art may be combined with the technical solutions in the embodiments of the disclosure as an optional solution, all of which belong to the scope of protection of the embodiments of the disclosure.

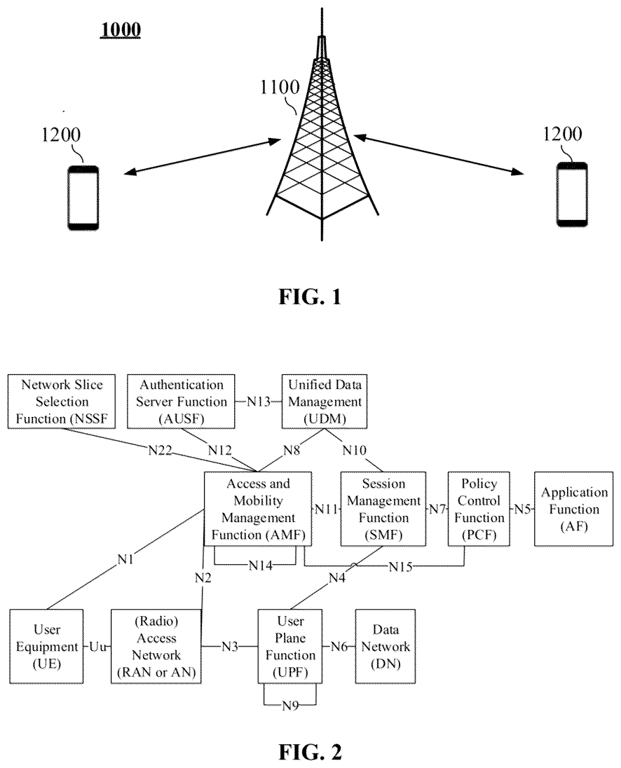

Illustratively, FIG. 2 illustrates a schematic diagram of architecture of a 5G network/system. The 5G network includes a UE and a (Radio) Access Network (RAN or AN) device, as well as a Data Network (DN) and multiple core network elements as follows: a Network Slice Selection Function (NSSF), an Authentication Server Function (AUSF), a Unified Data Management (UDM), an AMF, an SMF, a Policy Control Function (PCF), an Application Function (AF) and a UPF.

The UE connects to the AN at an access layer through a Uu interface for interacting an access layer message and transmitting wireless data. The UE performs a Non Access Stratum (NAS) connection to the AMF through a NI interface for interacting an NAS message. The AMF is a mobility management function in the core network, the SMF is a session management function in the core network, and the AMF is responsible for forwarding messages about session management between the UE and the SMF, in addition to mobility management of the UE. The PCF is a policy management function in the core network, which is responsible for formulating mobility management, session management, billing and other related policies for the UE. The UPF is a user plane function in the core network, which transmits data with an external data network through an N6 interface, and transmits data with the AN through an N3 interface.

A QoS model of the 5G network is illustrated in FIG. 3, in which a QoS control is implemented based on a QoS flow. After the UE accesses the 5G network through the Uu interface, the QoS flow for data transmission is established under a control of the SMF. The SMF provides QoS flow configuration information of each QoS flow to the base station, which specifically includes a 5G QoS Identifier (5QI) and an Allocation and Retention Priority (ARP), and information such as a bit rate requirement.

The 5QI is an index value corresponding to QoS characteristics such as a delay, a bit error rate requirement and the like. An example is as follows.

TABLE 1
An example of 5QI

| 5QI value | Delay | Bit error rate |
|---|---|---|
| 66 | 100 ms (ms) | 10⁻² |

The ARP is an allocation and retention resource priority allocated for the QoS flow by the base station. For each QoS flow, the base station schedules radio resources to guarantee a QoS requirement of the QoS flow based on the QoS flow configuration information received from the SMF.

Application layer data (for example, AR, VR, Cloud Gaming or the like) interacted between the UE and an application server or between the UE and a peer UE are usually the application layer data that has been encoded and compressed in a specific way. During the encoding process, media data may be divided into multiple media units, and each media unit is independently encoded, for example, a picture of 100*100 pixels is divided into 10 picture blocks of 100*10 pixels, and each picture block is independently encoded. After receiving the data, the UE decodes each picture block separately, and then combines them to obtain the entire picture. It is necessary to consider how to control a transmission of the media unit.

In the related art, the base station schedules the radio resources to guarantee the QoS requirement of the QoS flow based on the QoS flow configuration information received from the SMF. The delay and the bit error rate requirement corresponding to the 5QI in the QoS flow configuration information are applicable to each data packet, for example, the delay of 10 ms means that the base station needs to send each data packet in the QoS flow to the UE within 10 ms. The base station may discard the packet, which has not been sent for more than 10 ms.

Considering that multiple data packets will be independently encoded as one media unit during application layer encoding, if a certain number of data packets are discarded in the media unit, the UE cannot decode the media unit even if other data packets are successfully transmitted to the UE. That is, due to the loss of some data packets in the media unit, other data packets transmitted successfully are meaningless to the UE, and thus wasting air interface resources. The solution provided by the embodiments of the disclosure is mainly used for solving at least one of the above problems, and may be used for controlling the transmission of the media unit.

In order to enable a more detailed understanding of the features and technical content of the embodiments of the disclosure, the implementation of the embodiments of the disclosure will be described in detail below in combination with the drawings. The attached drawings are used for illustrating only and are not intended to limit the embodiments of the disclosure.

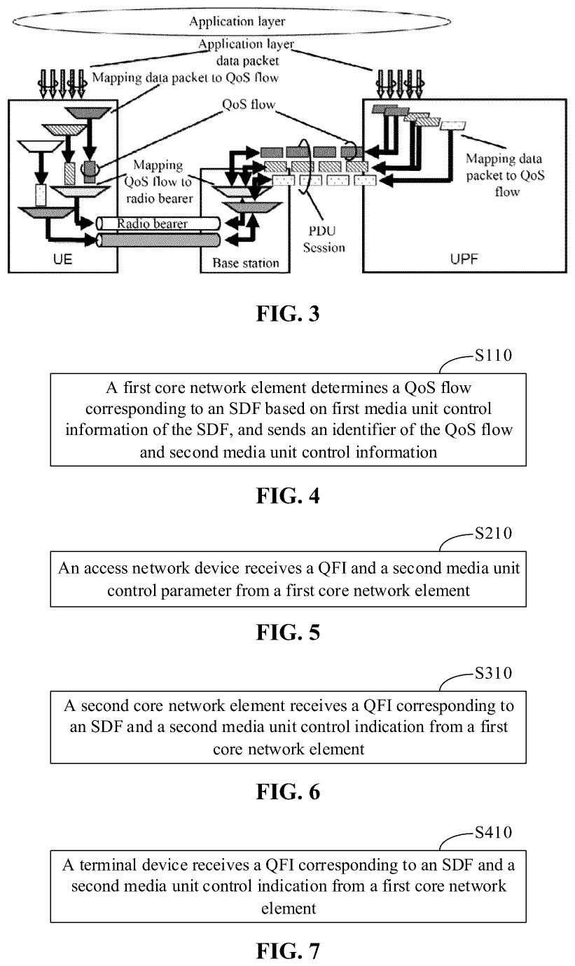

FIG. 4 is a schematic flowchart illustrating a method for controlling QoS according to an embodiment of the disclosure. Optionally, the method may be applied to the system illustrated in FIG. 1, but is not limited thereto. The method includes the following operations.

At operation S110, a first core network element determines a QoS flow corresponding to a Service Date Flow (SDF) based on first media unit control information of the SDF, and sends an identifier of the QoS flow (QOS Flow Identifier, QFI) and second media unit control information.

The second media unit control information indicates a QoS control at a media unit based handling.

In the embodiment of the disclosure, a media unit may include at least one data packet. The QoS control at the media unit based handling may be understood as a QoS control at the media unit granularity, that is, a unified transmission control is performed on all data packets in the media unit based on relevant parameters, instead of an individual transmission control on each data packet.

Optionally, the first media unit control information may include a first media unit control parameter and/or a first media unit control indication.

Illustratively, the first media unit control parameter may be a media unit-specific control parameter for the SDF. For example, the first media unit control parameter may include a level of the media unit and a QoS control parameter for the media unit such as a QoS level representation, a transmission layer priority, a bit error rate, a transmission delay, a bit rate requirement. Optionally, the first core network element may determine an appropriate QoS flow as the QoS flow corresponding to the SDF based on the first media unit control parameter.

Illustratively, the first media unit control indication is indication information characterizing the QoS control at the media unit based handling for the SDF. Optionally, the first core network element may identify the QoS flow applicable to the media unit as the QoS flow corresponding to the SDF.

With the above method, the first core network element may determine a QoS flow corresponding to the SDF based on the first media unit control information of the SDF, and send the second media unit control information while sending the QFI, to indicate the QoS control at the media unit based handling. In this way, the communication device that receives the QFI and the second media unit control information may perform the QoS control at the media unit based handling on related data based on the QFI, thereby avoiding a waste of air interface resources caused by performing the QoS control on each data packet in the media unit respectively.

Optionally, the QoS flow is only used for transmitting the SDF. In other words, the QoS flow is not used for transmitting other data, so that the communication device that performs the QoS control (such as an access network device) may identify a starting packet and/or an ending packet of each media unit in the data of the QoS flow (i.e., the data corresponding to the QFI) based on a preset manner. For example, the starting data packet is a first data packet in at least one data packet included in the media unit, or a specific data packet identifying a start of transmission of the media unit. For example, the ending data packet is a last data packet in the at least one data packet included in the media unit, or a specific data packet identifying an end of transmission of the media unit.

Optionally, the second media unit control information includes a second media unit control parameter and/or a second media unit control indication.

Optionally, the second media unit control indication is determined based on a first media unit control parameter and/or a first media unit control indication in the first media unit control information. For example, the second media unit control indication may be the first media unit control indication sent to the first core network element by another core network element, such as a policy management function. For another example, the first core network element may determine to perform the QoS control on the SDF at the media unit based handling based on the first media unit control parameter sent by another core network element, such as the policy management function, so as to determine the second media unit control indication.

Optionally, the second media unit control parameter is determined based on a first media unit control parameter in the first media unit control information. For example, the second media unit control parameter may be a QoS control parameter at an SDF level or a QoS flow level corresponding to the first media unit control parameter.

Illustratively, the first core network element may include an SMF.

Optionally, the first core network element may send the QFI and the second media unit control parameter to an access network device, such as a base station. Specifically, the operation of sending the QFI and the second media unit control information may include the following actions.

The QFI and the second media unit control parameter are sent to the access network device.

For example, after determining the QoS flow corresponding to the SDF, the session management network element sends the QFI and the second media unit control parameter to the access network device. The second media unit control parameter is at the QoS flow level, so that the access network device performs the QoS control on the data corresponding to the QFI at the media unit based handling based on the second media unit control parameter.

Optionally, in the interaction between the first core network element and the access network device, the operation of sending the QFI and the second media unit control information by the first core network element further includes that: the first core network element sends the second media unit control indication to the access network device.

Correspondingly, the access network device receives the QFI and the second media unit control parameter. As illustrated in FIG. 5, an embodiment of the disclosure further provides a method for controlling QoS, which includes the following operation.

At operation S210, an access network device receives a QFI and a second media unit control parameter from a first core network element. The second media unit control parameter is used for performing a QoS control at a media unit based handling on data corresponding to the QFI.

Optionally, the method further includes the following operation.

The access network device receives a second media unit control indication corresponding to the QFI from the first core network element.

Optionally, the first core network element may further send the QFI and the second media unit control information to other core network elements or a terminal device. Specifically, the operation of sending the QFI and the second media unit control information by the first core network element may include the following action.

The first core network element sends the QFI and the second media unit control indication to a second core network element and/or a terminal device.

Illustratively, the second core network element may include a UPF.

Optionally, the method may further include the following operation.

The first core network element sends a filter of the SDF to the second core network element and/or the terminal device.

For example, after determining the QoS flow corresponding to the SDF, the session management network element sends the filter (including, but not limited to, IP quintuple information or IP triple information) of the SDF to the UPF and/or the terminal device to identify the SDF, and sends the QFI and the second media unit control indication, so that the UPF and/or the terminal device performs an SDF detection on downlink data and/or uplink data, and learns that the QoS control at the media unit based handling is required to be performed on data in the SDF.

Optionally, in the interaction between the first core network element and the second core network element and/or the terminal device, the operation of sending the QFI and the second media unit control information by the first core network element further includes that: the first core network element sends the second media unit control parameter to the second core network element and/or the terminal device. The second media unit control parameter is a parameter at a QFI level.

Correspondingly, the second core network element receives the QFI and the second media unit control indication. As illustrated in FIG. 6, an embodiment of the disclosure further provides a method for controlling QoS, which includes the following operation.

At operation S310, a second core network element receives a QFI corresponding to an SDF and a second media unit control indication from a first core network element. The second media unit control indication indicates a QoS control at a media unit based handling for the SDF.

Optionally, the method further includes that: the second core network element receives a second media unit control parameter of the SDF from the first core network element.

Optionally, the method further includes that: the second core network element receives a filter of the SDF from the first core network element. Based on this, the second core network element may identify a data packet of the SDF from the received data packets.

Correspondingly, the terminal device receives the QFI and the second media unit control indication. As illustrated in FIG. 7, an embodiment of the disclosure further provides a method for controlling QoS, which includes the following operation.

At operation S410, a terminal device receives a QFI corresponding to an SDF and a second media unit control indication from a first core network element. The second media unit control indication indicates a QoS control at a media unit based handling for the SDF.

Optionally, the method further includes that: the terminal device receives a second media unit control parameter of the SDF from the first core network element.

Optionally, the method further includes that: the terminal device receives a filter of the SDF from the first core network element. Based on this, the terminal device may identify a data packet of the SDF from the received data packets.

In the methods provided by the above embodiments, the first media unit control information for the first core network element to determine the QoS flow corresponding to the SDF may be sent by a third core network element. Correspondingly, before the first core network element determining the QoS flow corresponding to the SDF, the method further includes that: the first core network element receives the filter of the SDF and/or the first media unit control information from the third core network element.

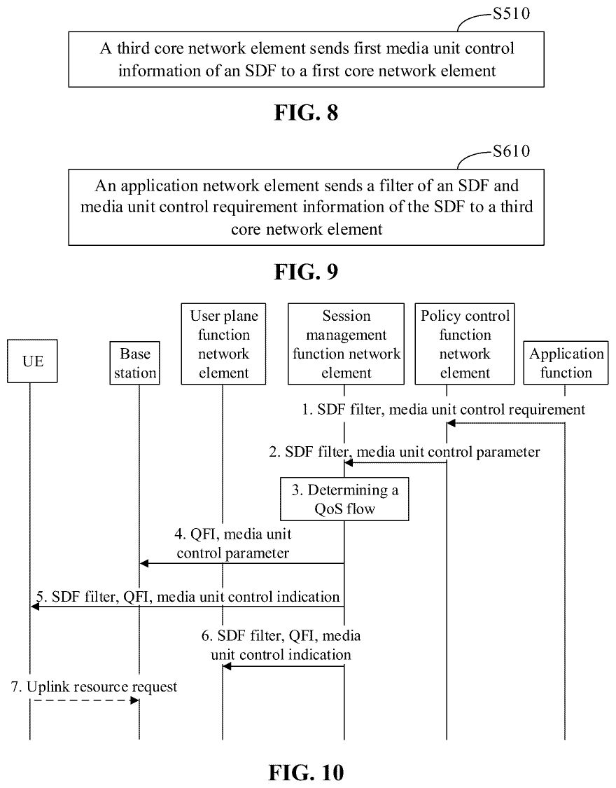

Correspondingly, as illustrated in FIG. 8, an embodiment of the disclosure further provides a method for controlling QoS, which includes the following operation.

At operation S510, a third core network element sends first media unit control information of an SDF to a first core network element. The first media unit control information is used for determining a QoS flow corresponding to the SDF and indicating a QoS control at a media unit based handling.

Optionally, the method further includes that: the third core network element sends a filter of the SDF to the first core network element.

Illustratively, the third core network element is a PCF.

Optionally, the first media unit control information sent by the third core network element to the first core network element is determined based on media unit control requirement information sent by an application network element, such as an AF. That is, the method further includes that: the third core network element receives a filter of the SDF and media unit control requirement information of the SDF from an application network element, and determines the first media unit control information of the SDF based on the media unit control requirement information.

Correspondingly, as illustrated in FIG. 9, an embodiment of the disclosure further provides a method for controlling QoS, which includes the following operations.

At operation S610, an application network element sends a filter of an SDF and media unit control requirement information of the SDF to a third core network element. The media unit control requirement information is used for determining first media unit control information of the SDF.

Illustratively, the media unit control requirement information characterizes a control requirement of the AF for the media unit in the SDF, including, for example, the level of the media unit, a QoS parameter for the media unit and the like.

The methods for controlling QoS for the media unit are described above from the perspectives of different communication devices through multiple embodiments. The signaling interaction at a control plane may be completed through each operation in the above embodiments, and each communication device may perform the QoS control at the media unit based handling on data in a specific SDF or the QoS flow in downlink data and/or uplink data based on the obtained information.

Optionally, the second core network element, such as the UPF, may identify the data of the specific SDF based on the obtained filter of the SDF, and may further identify the starting packet and/or the ending packet of the media unit in the data based on the preset manner. Specifically, the method further includes the following operation.

The second core network element receives N data packets matching the filter of the SDF from a data network, and identifies a starting data packet and/or an ending data packet of a media unit in the N data packets, N being an integer greater than or equal to 1.

Illustratively, the UPF may identify the starting data packet and the ending data packet of the media unit based on its own implementation. Optionally, the starting data packet and the ending data packet may be identified based on a pre-negotiated manner between the network and an application. For example, it is pre-negotiated that 0000 represents the starting data packet for identifying the start of transmission of the media unit; 1111 represents the ending data packet for identifying the end of transmission of the media unit. For another example, a first data packet received after a period in which no data packets of the SDF are received is determined to be the starting data packet of a media unit, and the media unit is considered to be finished after transmitting a specific length of data packets, or the media unit is considered to be finished if no new data packets are transmitted after transmitting a data packet for a specific time.

After identifying the starting data packet and/or the ending data packet of the media unit, the method may further include the following operation.

The second core network element sends M data packets to an access network device based on the N data packets.

The M data packets carry information for identifying the starting data packet and/or the ending data packet, and M is an integer greater than or equal to N.

Illustratively, the second core network element may process the received N data packets, so that the sent M packets carry the information for identifying the starting data packet and/or the ending data packet.

Illustratively, the processing of the received N packets by the second core network element may include at least one of the following operations.

After determining the starting data packet of the media unit, a specific identifier (which may be referred to as a first identifier) is marked in a header of the starting data packet.

After determining the ending data packet of the media unit, a specific identifier (which may be referred to as a second identifier) is marked in a header of the ending data packet.

After determining the starting data packet of the media unit, a special data packet (which may be referred to as a first data packet for identifying the start of transmission of the media unit) is sent to the access network device before sending the starting data packet.

After determining the ending data packet of the media unit, a special data packet (which may be referred to as a second data packet for identifying the end of transmission of the media unit) is sent to the access network device after sending the ending data packet.

Correspondingly, the information for identifying the starting data packet and/or the ending data packet includes at least one of: the first identifier added by the second core network element in the starting data packet for identifying the starting data packet; the second identifier added by the second core network element in the ending data packet for identifying the ending data packet; the first data packet generated by the second core network element for identifying the start of transmission of the media unit; or the second data packet generated by the second core network element for identifying the end of transmission of the media unit.

Optionally, the method further includes that: the second core network element adds the QFI into the M data packets. For example, the QFI is added to the header of each of the M data packets, so that the access network device may identify the data corresponding to the QFI in the received data, and perform the QoS control on the data at the media unit based handling based on the media unit control parameter corresponding to the QFI.

Optionally, for the access network device, the method further includes the following operations.

The access network device receives M data packets corresponding to the QFI from a second core network element, and identifies a media unit in the M data packets based on information for identifying a starting data packet and/or an ending data packet of the media unit carried in the M data packets. M is an integer greater than or equal to 1.

For example, the access network device identifies the media unit in the QoS flow by reading the specific identifier in the header of the data packet, the special first data packet and/or the special second data packet received from the UPF.

Further, the access network device may process the identified media unit at a media unit granularity (or the media unit based handling) based on the received second media unit control parameter. The processing may include the following operations.

If the QoS parameter for the media unit meets a requirement of the second media unit control parameter, all data packets in the media unit are sent, and/or, if the QoS parameter for the media unit does not meet the requirement of the second media unit control parameter, all data packets in the media unit are discarded.

For example, when a bit error rate of the media unit as a whole exceeds a bit error rate requirement in the media unit control parameter, the entire media unit is discarded. In another example, all data packets in the media unit are allocated with radio resources and transmitted together.

The terminal device may determine a QFI corresponding to uplink packets matching the filter of the SDF and request resource allocation from the access network device. Specifically, the method may further include the following operation.

The terminal device sends a radio resource request to an access network device based on a data size of a media unit matching the filter of the SDF.

That is, the terminal device requests the radio resource from the base station by treating the media unit as a whole. Illustratively, the request sent by the terminal device to the base station may include the size of the media unit.

According to the methods in the embodiments of the disclosure, the network determines the QoS flow corresponding to the SDF based on the media unit control information of the SDF, and indicates the QoS control at the media unit based handling, so as to achieve the transmission control at the media unit based handling and avoid wastage of air interface resources.

Specific application examples are provided below to better understand the methods for controlling QoS provided by the embodiments of the disclosure.

As illustrated in FIG. 10, in a practical application, the method for controlling QoS may include at least some of the following contents.

At operation 1, an Application Function (AF) provides a filter (for example, the filter includes, but is not limited to, IP quintuple information, or IP triple information) of an SDF and media unit control requirement information of the SDF for a Policy Control Function (PCF) network element located in a core network. Illustratively, the media unit control requirement information includes, but is not limited to, any one or a combination of the following information: a level of a media unit, which may indicate an importance level of the media unit in an application layer, or may indicate whether the media unit in the SDF is allowed to be skipped or discarded; or a QoS parameter for the media unit, for example, an identifier of a QoS level corresponding to the level of the media unit, a priority of a transmission layer, a bit error rate, a transmission delay, a bit rate requirement, and/or the like.

The media unit is determined by the application layer and is a set of one or more data packets.

Optionally, the AF further sends a media unit control indication to the PCF network element.

At operation 2, the PCF network element determines a media unit control parameter for the SDF based on the request of the AF. Illustratively, the media unit control parameter includes, but is not limited to, any one or a combination of the following information: the level of the media unit, which may indicate the importance level of the media unit in the application layer, or may indicate whether the media unit is allowed to be skipped or discarded; or the QoS parameter for the media unit, for example, the identifier of the QoS level, the priority of the transmission layer, the bit error rate, the transmission delay, the bit rate requirement, and/or the like.

The PCF network element sends the filter of the SDF and the media unit control parameter to a Session Management Function (SMF) network element. Optionally, the PCF network element further sends a media unit control indication to the SDF network element.

At operation 3, the SMF network element learns that a control at the media unit based handling is required to be performed on the SDF and determines a QoS flow for transmitting the SDF based on the media unit control parameter or the media unit control indication. The QoS flow is only used for transmitting the SDF.

At operation 4, the SMF network element sends a QFI and a media unit control parameter to a base station. Optionally, the SMF network element further sends a media unit control indication to the base station.

At operations 5 and 6, the SMF network element sends the filter of the SDF, the QFI, and the media unit control indication to a UPF and/or a UE.

The media unit control indication represents a need to control a set of data packets at the media unit based handling, rather than a single data packet. The media unit control indication may be received by the SMF network element from the PCF network element or determined by the SMF network element based on the media unit control parameter received from the PCF network element. Optionally, the SMF network element may further send the media unit control parameter to the UPF and/or the UE.

It should be noted that there is no requirement on the sending sequence of the above operations 4 to 6, that is, all the operations may be performed simultaneously or sequentially. If the operations are performed sequentially, the order between the operations 4 to 6 is not limited.

Data transmission may be performed after completing control plane signaling at the operations 4 to 6.

For downlink data, the UPF adds the QFI to a header of a data packet matching the filter of the SDF.

The UPF may identify a starting data packet and an ending data packet of the media unit based on its own implementation. For example, the starting data packet and the ending data packet may be identified based on a pre-negotiated manner between the network and an application (e.g., it is pre-negotiated that 0000 represents the starting data packet, and 1111 represents the ending data packet). For another example, a first data packet received after a period in which no data packets of the SDF are received is determined to be a starting data packet of a media unit, and the media unit is considered to be finished after transmitting a specific length of data packets, or the media unit is considered to be finished if no new data packet are transmitted after transmitting a data packet for a specific time.

After determining the starting data packet of the media unit, the UPF marks a specific identifier in a header of the starting data packet and sends the data packet to the base station, and the base station identifies the starting data packet of the media unit based on the identifier. Optionally, after determining the ending data packet of the media unit, the UPF marks a specific identifier in a header of the ending data packet and sends the data packet to the base station, and the base station identifies the ending data packet of the media unit based on the identifier. Optionally, after determining the starting data packet of the media unit, the UPF sends a special first data packet (e.g. an empty packet for identifying a start of transmission of the media unit) to the base station before sending this starting data packet to the base station, or sends a special second data packet (e.g. an empty packet for identifying an end of transmission of the media unit) to the base station after the end of the transmission of the media unit.

The base station identifies the media unit in the QoS flow by reading the header of the data packet, the special first data packet and/or the second data packet received from the UPF, and performs processing at a media unit granularity based on the media unit control parameter received in operation 4. For example, when a bit error rate of the media unit as a whole exceeds a bit error rate requirement in the media unit control parameter, the entire media unit is discarded. For another example, all data packets in the media unit are allocated with radio resources and transmitted together.

For uplink data, the UE determines a QFI corresponding to the data packet matching the filter of the SDF and sends an uplink resource request as illustrated at operation 7 in FIG. 10 to request a resource allocation from the base station. The UE requests the radio resource from the base station by treating the media unit as a whole, and the request sent to the base station includes a size of the media unit.

The specific arrangement and implementation of the embodiments of the disclosure have been described above from different perspectives through multiple embodiments. It can be seen that, using at least one embodiment described above, the first core network element sends the second media unit control information while sending the QFI to indicate the QoS control at the media unit based handling. In this way, the communication device that receives the QFI and the second media unit control information may perform the QoS control at the media unit based handling on related data based on the QFI, thereby avoiding a waste of the air interface resources caused by performing the QoS control on each data packet in the media unit respectively.

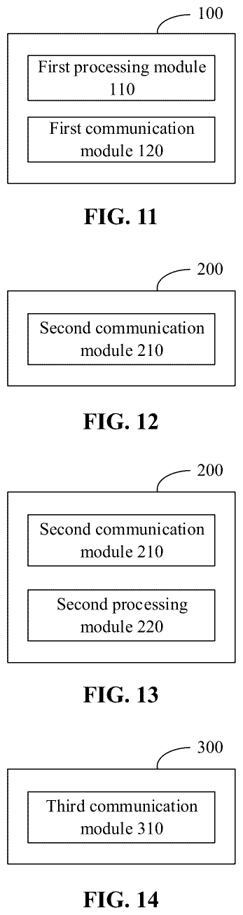

An embodiment of the disclosure further provides a first core network element 100 corresponding to the processing method in at least one of the above embodiments. Referring to FIG. 11, the first core network element 100 includes a first processing module 110 and a first communication module 120.

The first processing module 110 is configured to determine a QoS flow corresponding to an SDF based on first media unit control information of the SDF.

The first communication module 120 is configured to send an identifier of the QoS flow (QOS Flow Identifier, QFI) and second media unit control information. The second media unit control information indicates a QoS control at a media unit based handling.

Optionally, the first media unit control information includes a first media unit control parameter and/or a first media unit control indication.

Optionally, the QoS flow is only used for transmitting the SDF.

Optionally, the second media unit control information includes a second media unit control parameter and/or a second media unit control indication.

Optionally, the second media unit control indication is determined based on a first media unit control parameter and/or a first media unit control indication in the first media unit control information.

Optionally, the second media unit control parameter is determined based on a first media unit control parameter in the first media unit control information.

Optionally, the first communication module 120 is configured to send the QFI and the second media unit control parameter to an access network device.

Optionally, the first communication module 120 is configured to send the second media unit control indication to the access network device.

Optionally, the first communication module 120 is configured to send the QFI and the second media unit control indication to a second core network element and/or a terminal device.

Optionally, the first communication module 120 is configured to send the second media unit control parameter to the second core network element and/or the terminal device.

Optionally, the first communication module 120 is further configured to send a filter of the SDF to the second core network element and/or the terminal device.

Optionally, the first communication module 120 is further configured to receive the filter of the SDF from a third core network element.

Optionally, the first communication module 120 is further configured to receive the first media unit control information from the third core network element.

The first core network element 100 in the embodiment of the disclosure can implement functions corresponding to the first core network element in the above method embodiment. Processes, functions, implementations and beneficial effects corresponding to each module (sub-module, unit or component, etc.) in the first core network element 100 can be referred to corresponding description in the above method embodiment, and will not be repeated here. It should be noted that the function described for each module (sub-module, unit or component, etc.) in the first core network element 100 in the embodiment of the disclosure may be implemented by different modules (sub-module, unit or component, etc.) or by the same module (sub-module, unit or component, etc.), all of which can implement corresponding functions in the embodiment of the disclosure. In addition, the communication module in the embodiment of the disclosure can be implemented by a transceiver of the device, and some or all of the other modules can be implemented by a processor of the device.

FIG. 12 is a schematic block diagram of a second core network element 200 according to an embodiment of the disclosure. The second core network element 200 includes a second communication module 210.

The second communication module 210 is configured to receive an identifier of a QoS flow (QOS Flow Identifier, QFI) corresponding to an SDF and a second media unit control indication from a first core network element. The second media unit control indication indicates a QoS control at a media unit based handling for the SDF.

Optionally, the QoS flow is only used for transmitting the SDF.

Optionally, the second communication module 210 is further configured to receive a second media unit control parameter of the SDF from the first core network element.

Optionally, the second communication module 210 is further configured to receive a filter of the SDF from the first core network element.

Optionally, the second communication module 210 is further configured to receive N data packets matching the filter of the SDF from a data network.

Correspondingly, as illustrated in FIG. 13, the second core network element 200 further includes a second processing module 220.

The second processing module 220 is configured to identify a starting data packet and/or an ending data packet of a media unit in the N data packets. N is an integer greater than or equal to 1.

Optionally, the second communication module 210 is further configured to send M data packets to an access network device based on the N data packets.

The M data packets carry information for identifying the starting data packet and/or the ending data packet, and M is an integer greater than or equal to N.

Optionally, the information for identifying the starting data packet and/or the ending data packet includes at least one of: a first identifier added by the second core network element in the starting data packet for identifying the starting data packet; a second identifier added by the second core network element in the ending data packet for identifying the ending data packet; a first data packet generated by the second core network element for identifying a start of transmission of the media unit; or a second data packet generated by the second core network element for identifying an end of transmission of the media unit.

Optionally, the second processing module 220 is further configured to add the QFI into the M data packets.

The second core network element 200 in the embodiment of the disclosure can implement functions corresponding to the second core network element in the above method embodiment. Processes, functions, implementations and beneficial effects corresponding to each module (sub-module, unit or component, etc.) in the second core network element 200 can be referred to corresponding description in the above method embodiment, and will not be repeated here. It should be noted that the function described for each module (sub-module, unit or component, etc.) in the second core network element 200 in the embodiment of the disclosure can be implemented by different modules (sub-module, unit or component, etc.) or by the same module (sub-module, unit or component, etc.), all of which can implement corresponding functions in the embodiment of the disclosure. In addition, the communication module in the embodiment of the disclosure can be implemented by a transceiver of the device, and some or all of the other modules can be implemented by a processor of the device.

FIG. 14 is a schematic block diagram of an access network device 300 according to an embodiment of the disclosure. The access network device 300 may include a third communication module 310.

The third communication module 310 is configured to receive an identifier of a QoS flow (QOS Flow Identifier, QFI) and a second media unit control parameter from a first core network element. The second media unit control parameter is used for performing a QoS control at a media unit based handling on data corresponding to the QFI.

Optionally, the third communication module 310 is further configured to receive a second media unit control indication corresponding to the QFI from the first core network element.

Optionally, the third communication module 310 is further configured to receive M data packets corresponding to the QFI from a second core network element.

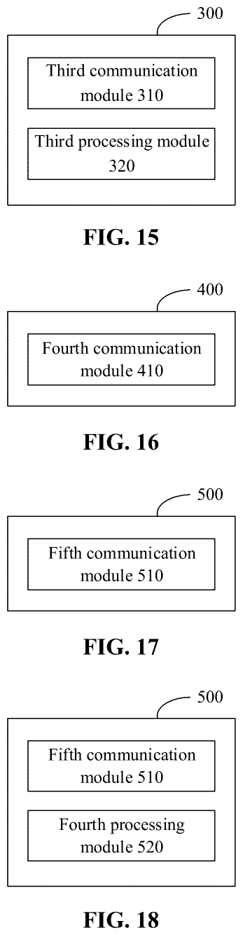

Correspondingly, as illustrated in FIG. 15, the access network device 300 further includes a third processing module 320.

The third processing module 320 is configured to identify a media unit in the M data packets based on information for identifying a starting data packet and/or an ending data packet of the media unit carried in the M data packets. M is an integer greater than or equal to 1.

Optionally, the information for identifying the starting data packet and/or the ending data packet of the media unit includes at least one of: a first identifier for identifying the starting data packet in the starting data packet; a second identifier for identifying the ending data packet in the ending data packet; a first data packet generated by the second core network element for identifying a start of transmission of the media unit; or a second data packet generated by the second core network element for identifying an end of transmission of the media unit.

The access network device 300 in the embodiment of the disclosure can implement functions corresponding to the access network device in the above method embodiment. Processes, functions, implementations and beneficial effects corresponding to each module (sub-module, unit or component, etc.) in the access network device 300 can be referred to corresponding description in the above method embodiment, and will not be repeated here. It should be noted that the function described for each module (sub-module, unit or component, etc.) in the access network device 300 in the embodiment of the disclosure can be implemented by different modules (sub-module, unit or component, etc.) or by the same module (sub-module, unit or component, etc.), all of which can implement corresponding functions in the embodiment of the disclosure. In addition, the communication module in the embodiment of the disclosure can be implemented by a transceiver of the device, and some or all of the other modules can be implemented by a processor of the device.

FIG. 16 is a schematic block diagram of a terminal device 400 according to an embodiment of the disclosure. The terminal device 400 may include a fourth communication module 410.

The fourth communication module 410 is configured to receive an identifier of a QoS flow (QOS Flow Identifier, QFI) corresponding to an SDF and a second media unit control indication from a first core network element. The second media unit control indication indicates a QoS control at a media unit based handling for the SDF.

Optionally, the QoS flow is only used for transmitting the SDF.

Optionally, the fourth communication module 410 is further configured to receive a second media unit control parameter of the SDF from the first core network element.

Optionally, the fourth communication module 410 is further configured to receive a filter of the SDF from the first core network element.

Optionally, the fourth communication module 410 is further configured to send a radio resource request to an access network device based on a data size of a media unit matching the filter of the SDF.

The terminal device 400 in the embodiment of the disclosure can implement functions corresponding to the terminal device in the above method embodiment. Processes, functions, implementations and beneficial effects corresponding to each module (sub-module, unit or component, etc.) in the terminal device 400 can be referred to corresponding description in the above method embodiment, and will not be repeated here. It should be noted that the function described for each module (sub-module, unit or component, etc.) in the terminal device 400 in the embodiment of the disclosure can be implemented by different modules (sub-module, unit or component, etc.) or by the same module (sub-module, unit or component, etc.), all of which can implement corresponding functions in the embodiment of the disclosure. In addition, the communication module in the embodiment of the disclosure can be implemented by a transceiver of the device, and some or all of the other modules can be implemented by a processor of the device.

FIG. 17 is a schematic block diagram of a third core network element 500 according to an embodiment of the disclosure. The third core network element 500 may include a fifth communication module 510.

The fifth communication module 510 is configured to send first media unit control information of an SDF to a first core network element. The first media unit control information is used for determining a QoS flow corresponding to the SDF and indicating a QoS control at a media unit based handling.

Optionally, the first media unit control information includes a first media unit control parameter and/or a first media unit control indication.

Optionally, the QoS flow is only used for transmitting the SDF.

Optionally, the fifth communication module 510 is further configured to send a filter of the SDF to the first core network element.

Optionally, the fifth communication module 510 is further configured to receive the filter of the SDF and media unit control requirement information of the SDF from an application network element.

Correspondingly, as illustrated in FIG. 18, the third core network element 500 further includes a fourth processing module 520.

The fourth processing module 520 is configured to determine the first media unit control information of the SDF based on the media unit control requirement information.

The third core network element 500 in the embodiment of the disclosure can implement functions corresponding to the third core network element in the above method embodiment. Processes, functions, implementations and beneficial effects corresponding to each module (sub-module, unit or component, etc.) in the third core network element 500 can be referred to corresponding description in the above method embodiment, and will not be repeated here. It should be noted that the function described for each module (sub-module, unit or component, etc.) in the third core network element 500 in the embodiment of the disclosure can be implemented by different modules (sub-module, unit or component, etc.) or by the same module (sub-module, unit or component, etc.), all of which can implement corresponding functions in the embodiment of the disclosure. In addition, the communication module in the embodiment of the disclosure can be implemented by a transceiver of the device, and some or all of the other modules can be implemented by a processor of the device.

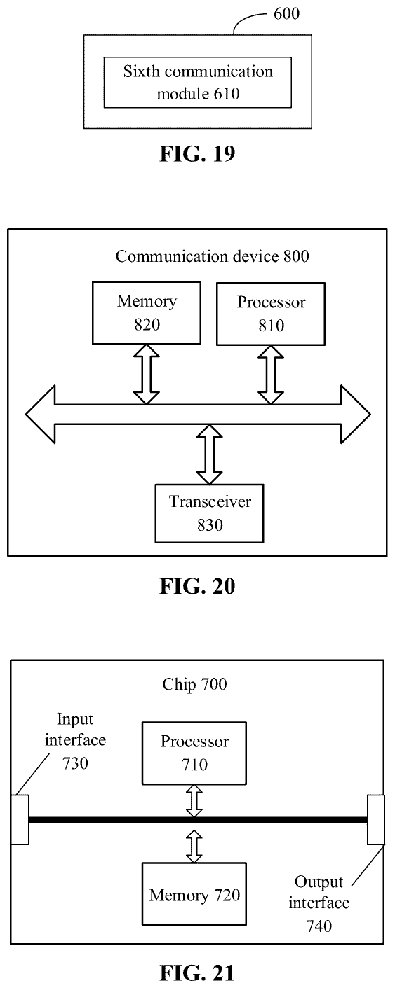

FIG. 19 is a schematic block diagram of an application network element 600 according to an embodiment of the disclosure. The application network element 600 may include a sixth communication module 610.

The sixth communication module 610 is configured to send a filter of an SDF and media unit control requirement information of the SDF to a third core network element. The media unit control requirement information is used for determining first media unit control information of the SDF.

Optionally, the first media unit control information includes a first media unit control parameter and/or a first media unit control indication.

The application network element 600 in the embodiment of the disclosure can implement functions corresponding to the application network element in the above method embodiment. Processes, functions, implementations and beneficial effects corresponding to each module (sub-module, unit or component, etc.) in the application network element 600 can be referred to corresponding description in the above method embodiment, and will not be repeated here. It should be noted that the function described for each module (sub-module, unit or component, etc.) in the application network element 600 in the embodiment of the disclosure can be implemented by different modules (sub-module, unit or component, etc.) or by the same module (sub-module, unit or component, etc.), all of which can implement corresponding functions in the embodiment of the disclosure. In addition, the communication module in the embodiment of the disclosure can be implemented by a transceiver of the device, and some or all of the other modules can be implemented by a processor of the device.

FIG. 20 is a schematic block diagram of a communication device 800 according to an embodiment of the disclosure. The communication device 800 includes a processor 810, which may call a computer program from a memory and run the computer program to implement the methods in the embodiments of the disclosure.

Optionally, the communication device 800 may further include a memory 820. The processor 810 may be configured to call the computer program from the memory 820 and run the computer program to implement the methods in the embodiments of the disclosure.

The memory 820 may be a separate device independent of the processor 810 or may be integrated into the processor 810.

Optionally, the communication device 800 may further include a transceiver 830, and the processor 810 may be configured to control the transceiver 830 to communicate with another device, in particular to send information or data to another device or receive information or data from another device.

The transceiver 830 may include a transmitter and a receiver. The transceiver 830 may further include an antenna. The number of the antennas may be one or more.

Optionally, the communication device 800 may be the first core network element in the embodiment of the disclosure, and the communication device 800 may implement corresponding processes implemented by the first core network element in each method in the embodiments of the disclosure. For simplicity, elaborations are omitted herein.

Optionally, the communication device 800 may be the second core network element in the embodiment of the disclosure, and the communication device 800 may implement corresponding processes implemented by the second core network element in each method in the embodiments of the disclosure. For simplicity, elaborations are omitted herein.

Optionally, the communication device 800 may be the access network device in the embodiment of the disclosure, and the communication device 800 may implement corresponding processes implemented by the access network device in each method in the embodiments of the disclosure. For simplicity, elaborations are omitted herein.

Optionally, the communication device 800 may be the terminal device in the embodiment of the disclosure, and the communication device 800 may implement corresponding processes implemented by the terminal device in each method in the embodiments of the disclosure. For simplicity, elaborations are omitted herein.

Optionally, the communication device 800 may be the third core network element in the embodiment of the disclosure, and the communication device 800 may implement corresponding processes implemented by the third core network element in each method in the embodiments of the disclosure. For simplicity, elaborations are omitted herein.

Optionally, the communication device 800 may be the application network element in the embodiment of the disclosure, and the communication device 800 may implement corresponding processes implemented by the application network element in each method in the embodiments of the disclosure. For simplicity, elaborations are omitted herein.

FIG. 21 is a schematic structure diagram of a chip according to an embodiment of the disclosure. The chip 700 includes a processor 710, and the processor 710 may call a computer program from a memory and run the computer program to perform the method in the embodiments of the disclosure.

Optionally, the chip 700 may further include a memory 720. The processor 710 may be configured to call the computer program from the memory 720 and run the computer program to perform the method in the embodiments of the disclosure.

The memory 720 may be a separate device independent of the processor 710, and may also be integrated into the processor 710.

Optionally, the chip 700 may further include an input interface 730. The processor 710 may be configured to control the input interface 730 to communicate with other devices or chips. Specifically, the input interface may be controlled to acquire information or data sent by other devices or chips.

Optionally, the chip 700 may further include an output interface 740. The processor 710 may control the output interface 740 to communicate with other devices or chips. Specifically, the output interface may be controlled to output information or data to other devices or chips.

Optionally, the chip may be applied to the first core network element in the embodiments of the disclosure, and the chip may be configured to implement corresponding processes implemented by the first core network element in each method in the embodiments of the disclosure. For simplicity, elaborations are omitted herein.

Optionally, the chip may be applied to the second core network element in the embodiments of the disclosure, and the chip may be configured to implement corresponding processes implemented by the second core network element in each method in the embodiments of the disclosure. For simplicity, elaborations are omitted herein.

Optionally, the chip may be applied to the access network device in the embodiments of the disclosure, and the chip may be configured to implement corresponding processes implemented by the access network device in each method in the embodiments of the disclosure. For simplicity, elaborations are omitted herein.

Optionally, the chip may be applied to the terminal device in the embodiments of the disclosure, and the chip may be configured to implement corresponding processes implemented by the terminal device in each method in the embodiments of the disclosure. For simplicity, elaborations are omitted herein.

Optionally, the chip may be applied to the third core network element in the embodiments of the disclosure, and the chip may be configured to implement corresponding processes implemented by the third core network element in each method in the embodiments of the disclosure. For simplicity, elaborations are omitted herein.

Optionally, the chip may be applied to the application network element in the embodiments of the disclosure, and the chip may be configured to implement corresponding processes implemented by the application network element in each method in the embodiments of the disclosure. For simplicity, elaborations are omitted herein.

It is to be understood that the chip mentioned in the embodiments of the disclosure may also be called a system-level chip, a system chip, a chip system or a system on chip, etc.

The processor mentioned above may be a general purpose processor, a Digital Signal Processor (DSP), a Field Programmable Gate Array (FPGA), an Application Specific Integrated Circuit (ASIC) or another programmable logical device, transistor logical device and discrete hardware component. The general purpose processor mentioned above may be a microprocessor or the processor may also be any conventional processor and the like.

The memory mentioned above may be a volatile memory or a non-volatile memory, or may include both the volatile and non-volatile memories. The non-volatile memory may be a Read-Only Memory (ROM), a Programmable ROM (PROM), an Erasable PROM (EPROM), an EEPROM or a flash memory. The volatile memory may be a Random Access Memory (RAM).

It is to be understood that the description of the memory is exemplary and non-limiting. For example, the memory in the embodiments of the disclosure may also be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM) and a Direct Rambus RAM (DR RAM) and the like. That is, the memory in the embodiments of the disclosure is intended to include, but not limited to, these and any other suitable types of memories.

The above embodiments of the disclosure may fully or partially implemented by software, hardware, firmware or any combination thereof. When implemented in software, the embodiments may be fully or partially implemented in the form of a computer program product. The computer program product includes one or more computer instructions. When the computer program instructions are loaded and executed on a computer, all or part of the processes or functions according to the embodiments of the disclosure are generated. The computer may be a general purpose computer, a special purpose computer, a computer network, or other programmable devices. The computer instructions may be stored in a computer-readable storage medium, or may be transmitted from one computer-readable storage medium to another computer-readable storage medium. For example, the computer instructions may be transmitted from one website site, computer, server, or data center to another website site, computer, server, or data center through a wired (e.g., a coaxial cable, an optical fiber, a digital subscriber line (DSL)) or a wireless (e.g., infrared, wireless, microwave, etc.) manner. The computer-readable storage medium may be any available medium that a computer can access, or may be a data storage device such as a server or a data center that contains one or more available media. The available medium may be a magnetic medium (such as, a floppy disk, a hard drive, a magnetic tape), an optical medium (e.g., a Digital Video Disc (DVD)), or a semiconductor medium (e.g., a solid state disk (SSD)) and the like.

It should be understood that in various embodiments of the disclosure, the serial numbers of the above-mentioned processes does not imply the execution order, the execution order of each process should be determined by its function and inherent logic, and should not constitute any limitation on implementation processes of the embodiments of the disclosure.

Those skilled in the art will clearly appreciate that, for convenience and simplicity of description, the specific operating processes of the above-described systems, apparatuses and units may refer to corresponding processes in the aforementioned method embodiments, and elaborations are omitted herein.

In the description of this specification, reference to the terms such as “an embodiment”, “some embodiments”, “an example”, “a specific example”, or “some examples” mean that specific features, structures, materials or characteristics described in connection with the embodiment or example are included in at least one embodiment or example of the disclosure. Further, the described specific features, structures, materials or characteristics may be combined in a suitable manner in any one or more embodiments or examples. Further, those skilled in the art may combine and assemble different embodiments or examples described herein as well as features of different embodiments or examples with each other without conflict.

Furthermore, the terms “first” and “second” are used for descriptive purposes only and are not to be understood as indicating or implying relative importance or implying the number of technical features indicated. Thus, the features defined as “first”, “second” may explicitly or implicitly include at least one of the features. In the description of the disclosure, “multiple” means two or more, unless otherwise defined.

Described above are merely specific embodiments of the disclosure and the scope of protection of the disclosure is not limited thereto. Any variation or replacement easily conceivable by those skilled in the art within the technical scope disclosed by the disclosure shall fall within the scope of protection of the disclosure. Therefore, the scope of protection of the disclosure shall be subject to the scope of protection of the claims.

1. A method for controlling Quality of Service (QOS), comprising:
determining, by a first core network element, a QoS flow corresponding to a Service Data Flow (SDF) based on first media unit control information of the SDF; and
sending an identifier of the QoS flow (QoS Flow Identifier, QFI) and second media unit control information.

2. The method of claim 1, wherein the second media unit control information indicates a QoS control at a media unit based handling.

3. The method of claim 1, wherein the first media unit control information comprises a first media unit control parameter and/or a first media unit control indication.

4. The method of claim 3, wherein the first media unit control parameter comprises one or more of: a bit error rate or a transmission delay.

5. The method of claim 2, wherein the media unit is a set of one or more data packets.

6. A first core network element, comprising:
a processor;
a memory for storing a computer program; and
a transceiver,
wherein the processor is configured to call the computer program stored in the memory and run the computer program to:
determine a Quality of Service (QOS) flow corresponding to a Service Data Flow (SDF) based on first media unit control information of the SDF; and
control the transceiver to send an identifier of the QoS flow (QOS Flow Identifier, QFI) and second media unit control information.

7. The first core network element of claim 6, wherein the second media unit control information indicates a QoS control at a media unit based handling.

8. The first core network element of claim 6, wherein the first media unit control information comprises a first media unit control parameter and/or a first media unit control indication.

9. The first core network element of claim 6, wherein the QoS flow is only used for transmitting the SDF.

10. The first core network element of claim 6, wherein the second media unit control information comprises a second media unit control parameter and/or a second media unit control indication.

11. The first core network element of claim 10, wherein a first media unit control parameter in the first media unit control information or the second media unit control parameter comprises one or more of: a bit error rate or a transmission delay.

12. The first core network element of claim 7, wherein the media unit is a set of one or more data packets.

13. The first core network element of claim 10, wherein the second media unit control parameter is determined based on a first media unit control parameter in the first media unit control information.

14. The first core network element of claim 10, wherein the processor is further configured to control the transceiver to:
send the QFI and the second media unit control parameter in the second media unit control information to an access network device.

15. The first core network element of claim 6, wherein the processor is further configured to control the transceiver to:
receive the first media unit control information from a third core network element.

16. The first core network element of claim 15, wherein the first core network element is a Session Management Function (SMF), and the third core network element is a Policy Control Function (PCF).

17. A third core network element, comprising:
a processor;
a memory for storing a computer program; and
a transceiver,
wherein the processor is configured to call the computer program stored in the memory and run the computer program to:
control the transceiver to send first media unit control information of a Service Data Flow (SDF) to a first core network element,
wherein the first media unit control information is used for determining a Quality of Service (QOS) flow corresponding to the SDF.

18. The third core network element of claim 17, wherein the first media unit control information comprises a first media unit control parameter and/or a first media unit control indication.

19. The third core network element of claim 17, wherein the QoS flow is only used for transmitting the SDF.

20. The third core network element of claim 17, wherein the processor is further configured to:
control the transceiver to receive a filter of the SDF and media unit control requirement information of the SDF from an application network element; and
determine the first media unit control information of the SDF based on the media unit control requirement information.
